(19) United States
(12) Patent Application Publication
(10) Pub. No.: US 2026/0161598 A1
(43) Pub. Date: Jun. 11, 2026

(54) SYSTEM-ON-CHIP FOR SUPPORTING DATA PREFETCH OPERATION AND OPERATING METHOD OF THE SYSTEM-ON-CHIP

(71) Applicant: SAMSUNG ELECTRONICS CO., LTD., Suwon-si (KR)

(72) Inventors: Junhee YOO, Suwon-si (KR); Junseok Park, Suwon-si (KR)

(73) Assignee: SAMSUNG ELECTRONICS CO., LTD., Suwon-si (KR)

(21) Appl. No.: 19/364,540

(22) Filed: Oct. 21, 2025

(30) Foreign Application Priority Data
Oct. 23, 2024 (KR) 10-2024-0146049
Dec. 20, 2024 (KR) 10-2024-0193321

(51) Int. Cl. G06F 15/78; G06F 13/28

(52) U.S. Cl. CPC G06F 15/7807; G06F 13/28

(57) ABSTRACT

A system-on-chip, including: an accelerator configured to generate a demand request for demand data corresponding to a neural network operation, based on an instruction received from a host processor, and to generate a prefetch request for prefetch data based on a memory access pattern predicted according to the neural network operation; a memory controller configured to read the demand data from a memory based on the demand request, and to read the prefetch data from the memory based on the prefetch request; and a system cache configured to store, as read data, at least one of the prefetch data and the demand data read from the memory, wherein the accelerator is configured to perform the neural network operation on the read data received from the system cache.

### CROSS-REFERENCE TO RELATED APPLICATION

This application is based on and claims priority under 35 U.S.C. § 119 to Korean Patent Application No. 10-2024-0146049, filed on Oct. 23, 2024, and Korean Patent Application No. 10-2024-0193321, filed on Dec. 20, 2024, in the Korean Intellectual Property Office, the disclosures of which are incorporated by reference herein in their entireties.

### BACKGROUND

### 1. Field

The present disclosure relates to a system-on-chip, and more particularly, to an accelerator for supporting a data prefetch operation, a system-on-chip for supporting a data prefetch operation, and a process for operating the system-on-chip.

### 2. Description of Related Art

System-on-chip may refer to a technology in which a complicated system having various functions is integrated into a single semiconductor chip. With the increasing integration of computers, communication, and broadcasting, the demands for application specific integrated circuit (ASIC) and specific-purpose standard products are advancing on system-on-chip. Also, the miniaturization and lightness of information technology (IT) devices are facilitating the industry associated with system-on-chips.

Furthermore, as the demand for artificial intelligence (AI) operations based on a neural network increases, dedicated processors for AI operations are being developed. As AI operations advance, the amount of memory used for AI operations is increasing. Therefore, there is a need for system-on-chips or dedicated processors for enhancing the performance of dedicated processors for AI operations while efficiently using a bandwidth of memory.

### SUMMARY

Provided is a system-on-chip, which may support a data prefetch operation in order to efficiently use a memory bandwidth, and a process for operating the system-on-chip.

Additional aspects will be set forth in part in the description which follows and, in part, will be apparent from the description, or may be learned by practice of the presented embodiments.

In accordance with an aspect of the disclosure, a system-on-chip includes: an accelerator configured to generate a demand request for demand data corresponding to a neural network operation, based on an instruction received from a host processor, and to generate a prefetch request for prefetch data based on a memory access pattern predicted according to the neural network operation; a memory controller configured to read the demand data from a memory based on the demand request, and to read the prefetch data from the memory based on the prefetch request; and a system cache configured to store, as read data, at least one of the prefetch data and the demand data read from the memory, wherein the accelerator is configured to perform the neural network operation on the read data received from the system cache.

In accordance with an aspect of the disclosure, an operating method of a system-on-chip includes: generating a demand request for demand data corresponding to a neural network operation, based on an instruction received from a host processor; generating a prefetch request for prefetch data based on a memory access pattern predicted according to the neural network operation; reading data from a memory based on at least one of the demand request and the prefetch request; storing the read data in a system cache; and performing the neural network operation on the read data received from the system cache, wherein a priority of the demand request is higher than a priority of the prefetch request.

In accordance with an aspect of the disclosure, an accelerator for performing a task corresponding to an instruction received from a host processor includes: an execution sequence generator configured to dispatch a plurality of operations associated with the task; a fetch module configured to generate a demand request for demand data corresponding to the plurality of operations; a prefetch module configured to generate a prefetch request for prefetch data based on a memory access pattern corresponding to the plurality of operations; a buffer memory configured to store at least one of the demand data and the prefetch data; a cache memory configured to receive data including at least one of the demand data and the prefetch data from the buffer memory, and store the received data; and a compute unit configured to perform the plurality of operations on the received data stored in the cache memory, wherein a priority of the demand request is higher than a priority of the prefetch request.

The system-on-chip may include a neural processing unit (NPU), and the performing of the neural network operation may include performing at least one of a matrix operation and a convolution operation by using the NPU.

The accelerator may be configured to correspond to a neural processing unit (NPU) or a graphics processing unit (GPU), and the operations may include at least one of a matrix operation and a convolution operation.

The memory access pattern may be configured to be previously determined based on the operations, and the memory access pattern may include a memory read pattern and a memory write pattern each corresponding to the demand request generated by the fetch module.

The prefetch module may include an access sequence queue configured to store the memory access pattern and a controller configured to generate the prefetch request.

When the buffer memory is idle, the prefetch module may be configured to issue the prefetch request, and the prefetch data is transferred to the cache memory, and when the buffer memory is busy, the prefetch request may be deleted.

The fetch module may be configured to generate a demand count corresponding to the number of times the demand request is issued, and the prefetch module may be configured to generate a prefetch count corresponding to the number of times the prefetch request is issued and compare the demand count with the prefetch count and control a prefetch operation based on a comparison result.

### BRIEF DESCRIPTION OF THE DRAWINGS

The above and other aspects, features, and advantages of certain embodiments of the present disclosure will be more apparent from the following description taken in conjunction with the accompanying drawings in which:

FIG. 1 is a block diagram illustrating an electronic device, according to an embodiment;

FIG. 2 is a block diagram illustrating examples of some elements of the electronic device of FIG. 1, according to an embodiment;

FIGS. 3A and 3B illustrate access sequence queues according to some embodiments;

FIG. 4 is a block diagram illustrating an electronic device according to an embodiment;

FIG. 5 illustrates a direct memory access (DMA) operation based on a demand request of the electronic device of FIG. 4, according to an embodiment;

FIG. 6 illustrates a prefetch operation based on a prefetch request of the electronic device of FIG. 4, according to an embodiment;

FIG. 7 illustrates an operation of a system-on-chip including a DMA operation and a prefetch operation, according to an embodiment;

FIG. 8 illustrates an operation of a system-on-chip including a DMA operation and a prefetch operation, according to an embodiment;

FIG. 9 illustrates an operation of a system-on-chip including a DMA operation and a prefetch operation, according to an embodiment;

FIG. 10 is a block diagram illustrating an electronic device, according to an embodiment;

FIG. 11 is a block diagram illustrating a system-on-chip, according to an embodiment;

FIG. 12 is a flowchart illustrating process for operating a system-on-chip, according to an embodiment;

FIG. 13 is a flowchart illustrating a process for operating a system-on-chip, according to an embodiment;

FIG. 14 is a block diagram illustrating an accelerator, according to an embodiment;

FIG. 15 illustrates a software layer of a system-on-chip, according to an embodiment; and

FIG. 16 is a block diagram illustrating an electronic system, according to an embodiment.

### DETAILED DESCRIPTION

Hereinafter, embodiments will be described in detail with reference to the accompanying drawings. Like reference numerals refer to like elements in the drawings, and their repeated descriptions are omitted.

As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

As used herein, when an action or operation is referred to as occurring “in response to” an event or occurrence, this may mean that action or operation occurs directly or indirectly in response to or based on the event or occurrence.

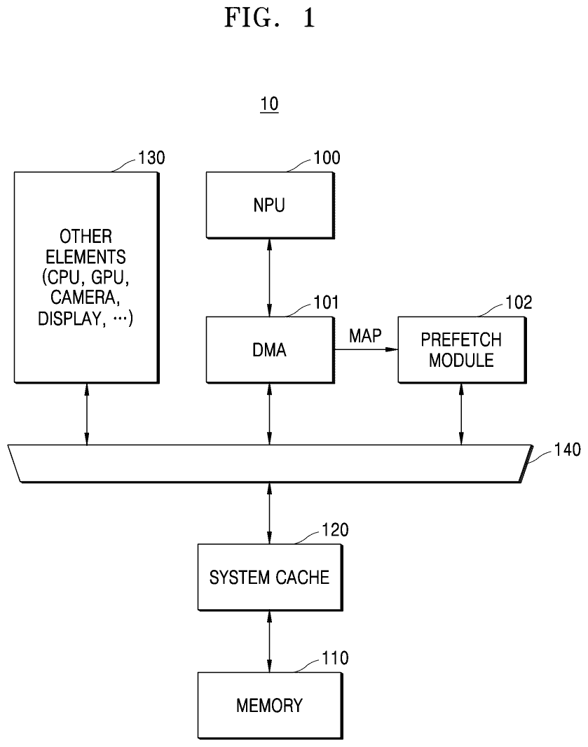

FIG. 1 is a block diagram illustrating an electronic device 10 according to an embodiment.

Referring to FIG. 1, the electronic device 10 may include a neural processing unit (NPU) 100, a memory 110, and a system cache 120. Also, the electronic device 10 may further include a direct memory access (DMA) engine 101 and a prefetch module 102. In the example shown in FIG. 1, the DMA engine 101 and the prefetch module 102 are illustrated as being disposed outside the NPU 100, but embodiments are not limited thereto. In some embodiments, at least one of the DMA engine 101 and the prefetch module 102 may be included in the NPU 100.

The NPU 100 may be a processor for efficiently performing an artificial intelligence (AI) operation using a neural network, and, for example, may perform an AI operation such as deep learning, image processing, voice recognition, and natural language processing. Hereinafter, an AI operation based on the neural network may be referred to as a “neural network operation”. For example, the neural network operation may include various arithmetic operations such as a matrix operation, a vector operation, and a convolution operation. However, the neural network operation is not limited to the above description and may include an arbitrary arithmetic operation based on the neural network.

According to an embodiment, the NPU 100 may include a device which executes a machine learning model. For example, the NPU 100 may be a hardware block which is designed for executing the machine learning model. The machine learning model may be a model based on at least one of a neural network, a decision tree, a support vector machine, regression analysis, a Bayesian network, and a genetic algorithm. The neural network, which may be referred to as an artificial neural network, may include at least one of a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and the like, but embodiments are not limited thereto.

The DMA engine 101 may perform a DMA operation on data used to perform the neural network operation and data generated as a result of performing the neural network operation. The DMA engine 101 may generate a memory access pattern MAP representing a pattern which reads and writes a memory, based on DMA. As an example, the memory access pattern MAP may include address information. As another example, the memory access pattern MAP may include size information. As yet another example, the memory access pattern MAP may include the number and/or amount of accesses to the memory 110 or the system cache 120. As a further example, the memory access pattern MAP may include a use history of the memory 110 or the system cache 120.

In this case, the memory access pattern MAP may include a memory read pattern and a memory write pattern. The memory read pattern may include a data pattern read from the memory 110 or the system cache 120, and for example, may include address information, a data size, and an offset. The memory write pattern may include a data pattern written in the memory 110 or the system cache 120, and for example, may include address information, a data size, and an offset. For example, the memory access pattern MAP may include a linear pattern, a linear by chunk pattern, a strided pattern, a strided by chunk pattern, or a random pattern.

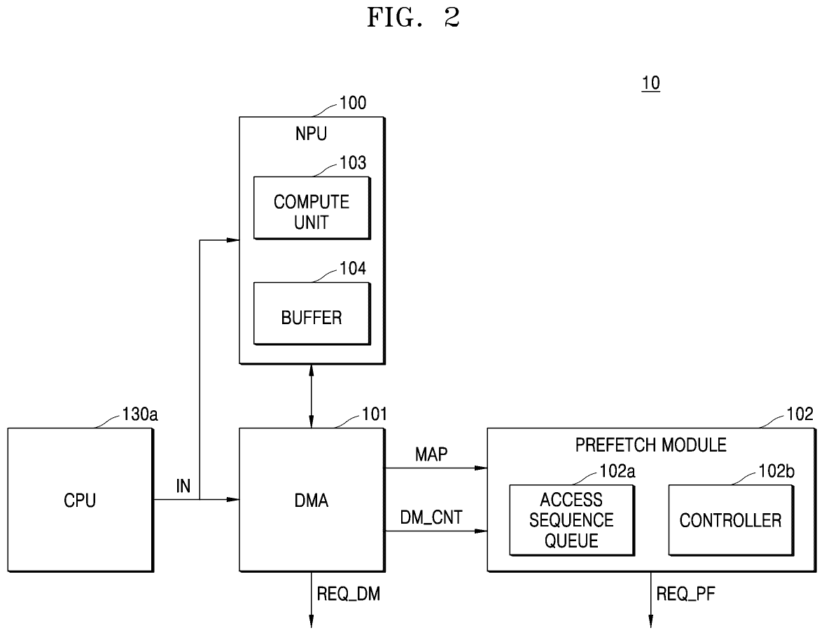

In an embodiment, the DMA engine 101 may read data, used for performing the neural network operation in the NPU 100, from the memory 110 or the system cache 120. The data read from the memory 110 may be stored in the system cache 120, and data stored in the system cache 120 may be loaded into a buffer (e.g., the buffer 104 of FIG. 2) included in the NPU 100. In an embodiment, the DMA engine 101 may write data, generated as a result of performing the neural network operation in the NPU 100, in the memory 110 or the system cache 120. For example, the data stored in the buffer of the NPU 100 may be loaded into the system cache 120, and the data loaded into the system cache 120 may be stored in the memory 110.

The prefetch module 102 may control a data prefetch operation or a prefetch operation based on the memory access pattern MAP generated by the DMA engine 101. Here, the prefetch operation may denote an operation which starts to previously fetch data, predicted to be used later, to a memory of an upper layer in a memory of a lower layer, and thus, decreases memory access latency and enhances system performance. When a prefetch method is applied to an operation of an accelerator (e.g., the NPU 100), the performance of the NPU 100 may be efficiently enhanced.

In an embodiment, the prefetch module 102 may issue a prefetch request for loading prefetch data into the system cache 120 from the memory 110, based on the memory access pattern MAP. In an embodiment, when the memory 110 or a memory system including the memory 110 is in an idle state, the prefetch module 102 may issue the prefetch request. In some embodiments, the prefetch module 102 may be implemented with hardware, software, firmware, and/or a combination thereof.

The electronic device 10 may further include, for example, other elements 130, which may include at least one of a central processing unit (CPU), a graphics processing unit (GPU), a camera, and a display. The elements included in the electronic device 10 may communicate with each other using an interface 140. For example, at least one of the NPU 100, the DMA engine 101, the prefetch module 102, and the other elements 130 may access the system cache 120 using the interface 140. In an embodiment, the interface 140 may function as a multiplexer and may transfer, to the system cache 120, signals such as a command and a request each received from the NPU 100, the DMA engine 101, the prefetch module 102, or the other elements 130.

According to an embodiment, the interface 140 may be referred to as an inter-connector. The interface 140 may provide a memory access path to the NPU 100, the DMA engine 101, the prefetch module 102, and the other elements 130. The NPU 100, the DMA engine 101, the prefetch module 102, and the other elements 130 may access the memory 110 using the interface 140. The interface 140 may provide a path of each of data, an address, and a control signal through a plurality of channels.

The memory 110 may be used as a main memory device of the electronic device 10 and may include a volatile memory such as dynamic random access memory (DRAM) and/or static random access memory (SRAM). However, embodiments are not limited thereto, and in some embodiments, the memory 110 may include a non-volatile memory such as a flash memory, phase change random access memory (PRAM), and/or resistive random access memory (RRAM). In some embodiments, the memory 110 may include a three-dimensional (3D) memory such as high bandwidth memory (HBM). According to an embodiment, the memory 110 may be referred to as a system memory. In an embodiment, the memory 110 may store at least one of input data to be inferred (e.g., input data on which a neural network operation such as an inference operation are to be performed), parameters of a neural network, and instructions which are to be executed in the accelerator (e.g., the NPU 100). According to an embodiment, the memory 110 may be implemented as an on-chip memory or an off-chip memory. For example, in some embodiments the off-chip memory may have a memory capacity which is greater than that of the on-chip memory.

The system cache 120 may be a high-speed buffer memory disposed between the memory 110, the NPU 100, and the other elements 130, and may be shared by the NPU 100 and the other elements 130. The system cache 120 may store instructions or data accessed, and may thus decrease the frequency or number of memory accesses used to support high-speed processing of the electronic device 10. Therefore, in order to efficiently utilize the system cache 120 having a small capacity, it may be beneficial to maximize the probability that the data or instructions used by the NPU 100 and other elements 130 to perform computations or process programs are found in the system cache 120, thereby minimizing the latency caused by data absence in the system cache 120 (e.g., cache misses). As described above, in order to maximize a hit ratio of the system cache 120, the prefetch module 102 may predict a command or data used to perform a neural network operation of the NPU 100 in order to fetch the instructions or the data in the system cache 120, and may allow the NPU 100 to perform the neural network operation without delay.

In FIG. 1, an example is illustrated in which the electronic device 10 includes the NPU 100, but embodiments are not limited thereto. For example, the NPU 100 may correspond to an example of an accelerator, and embodiments described below are not limited to the NPU 100. Therefore, the electronic device 10 may be referred to as an accelerator system. For example, the accelerator may be implemented using one or more processing resources suitable for the accelerator, and for example, may be implemented using at least one of a GPU, an NPU, a tensor processing unit (TPU), a combination logic, a sequential logic, one or more timers, a counter, a register, a state machine, complex programmable logic devices (CPLD), field programmable gate arrays (FPGA), an ASIC, a CPU such as a complex instruction set computer (CISC) processor such as x86 processor and/or reduced instruction set computer (RISC) processor such as an ARM processor, and any combination thereof.

FIG. 2 is a block diagram illustrating examples of additional details regarding some elements of the electronic device 10 of FIG. 1 according to an embodiment.

Referring to FIGS. 1 and 2, a CPU 130a may correspond to an example of a host processor, and may generate an instruction IN indicating a neural network operation, based on an input of an application or a user. For example, the CPU 130a may receive a request for processing an inference operation based on a neural network in an accelerator (e.g., the NPU 100) and may transfer the instruction IN to the accelerator (e.g., the NPU 100) in response to the received request. For example, the request may be for data inference based on the neural network, and for example, may be for allowing the accelerator (e.g., the NPU 100) to execute the neural network operation to obtain a data inference result, for voice recognition, machine translation, machine interpretation, object recognition, pattern recognition, and computer vision.

The NPU 100 may include a compute unit 103 and a buffer 104. The compute unit 103 may perform the neural network operation on data loaded into the buffer 104, in response to the instruction IN received from the CPU 130a. To efficiently perform the neural network operation, it may be beneficial to quickly load data into the buffer 104.

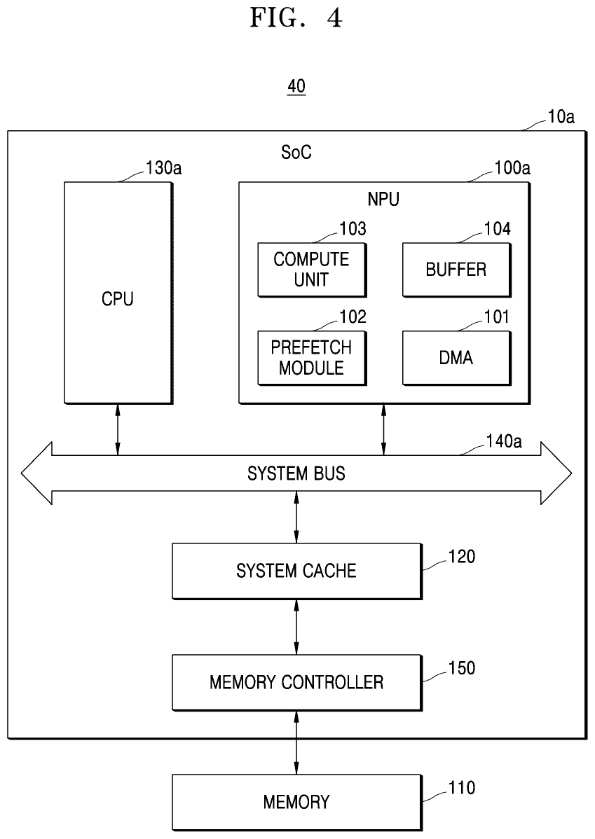

The DMA engine 101 may generate a demand request REQ_DM for reading data corresponding to the neural network operation from a memory, in response to the instruction IN received from the CPU 130a. The DMA engine 101 may transfer the demand request REQ_DM to a memory controller (e.g., the memory controller 150 of FIG. 4). Based on the demand request REQ_DM, a DMA operation of actually loading data, stored in the memory 110 or the system cache 120, in the buffer 104 may be performed.

Also, the DMA engine 101 may generate a memory access pattern MAP based on the demand request REQ_DM and may generate a demand issue count or demand count DM_CNT representing the number of times that the demand request REQ_DM is issued. For example, the DMA engine 101 may increase or increment the demand count DM_CNT whenever the demand request REQ_DM is issued (e.g., each time that the demand request REQ_DM is issued).

The prefetch module 102 may generate a prefetch request REQ_PF for prefetch data which is predicted to be needed for the neural network operation, based on the memory access pattern MAP received from the DMA engine 101. The prefetch module 102 may transfer the prefetch request REQ_PF to the memory controller (e.g., the memory controller 150 of FIG. 4). Based on the prefetch request REQ_PF, a read operation on the memory 110 may be performed, and thus, a prefetch operation of moving data, stored in the memory 110, to the system cache 120 may be performed.

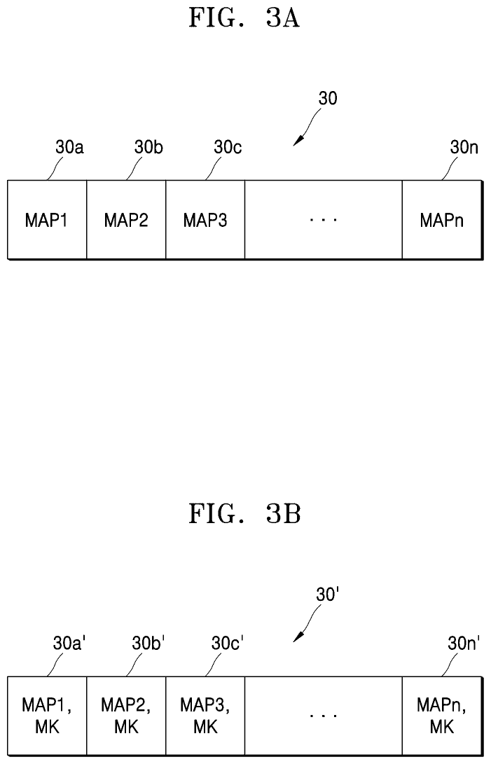

In an embodiment, the prefetch module 102 may include an access sequence queue 102a and a controller 102b. The access sequence queue 102a may store the memory access pattern MAP received from the DMA engine 101. In an embodiment, the access sequence queue 102a may correspond to a perfect access sequence queue (PASQ) having a known (e.g., predetermined) memory access sequence. An example of the access sequence queue 102a is described below in detail with reference to FIGS. 3A and 3B.

FIG. 3A illustrates an access sequence queue 30 according to an embodiment.

Referring to FIG. 3A, the access sequence queue 30 may store memory access sequences corresponding to the memory access pattern MAP. For example, the access sequence queue 30 may be implemented using first in first out (FIFO) storage of address information and size information (e.g., (base_address, size_in_bytes) pairs). In an embodiment, the access sequence queue 30 may be maintained in the NPU 100. In an embodiment, the access sequence queue 30 may be maintained alongside the NPU 100. The access sequence queue 30 may have a sufficiently large queue size or queue depth so that a prefetch operation according to an embodiment may be smoothly performed. In an embodiment, when the access sequence queue 30 includes a space at which more entries are added, a table storing address information and size information may be stored in the memory 110 while the entries are being filled in the access sequence queue 30.

For example, the access sequence queue 30 may include a plurality of PASQ entries. For example, the plurality of PASQ entries included in the access sequence queue 30 may include a first PASQ entry 30a, a second PASQ entry 30b, a third PASQ entry 30c, through an n-th PASQ entry 30n, where n is an arbitrary integer and may be variously changed according to embodiments. The plurality of PASQ entries 30a to 30n may include a plurality of memory access patterns. For example, the first PASQ entry 30a may include a first memory access pattern MAP1, the second PASQ entry 30b may include a second memory access pattern MAP2, the third PASQ entry 30c may include a third memory access pattern MAP3, and the n-th PASQ entry 30n may include an n-th memory access pattern MAPn. The memory access patterns MAP1 to MAPn may include address information and size information.

FIG. 3B illustrates an access sequence queue 30′ according to an embodiment.

Referring to FIG. 3B, the access sequence queue 30′ may store memory access sequences corresponding to a memory access pattern MAP. For example, the access sequence queue 30′ may include a plurality of PASQ entries. For example, the plurality of PASQ entries included in the access sequence queue 30′ may include a first PASQ entry 30a′, a second PASQ entry 30b′, a third PASQ entry 30c′, through an n-th PASQ entry 30n′. Here, n may be an arbitrary positive integer and may be variously changed according to embodiments. The plurality of PASQ entries 30a′ to 30n′ may respectively include a plurality of memory access patterns, and each of the plurality of PASQ entries 30a′ to 30n′ may include a marker MK. For example, the PASQ entry 30a′ may include a memory access pattern MAP1′ and the marker MK, the second PASQ entry 30b′ may include a second memory access pattern MAP2′ and the marker MK, the third PASQ entry 30c′ may include a third memory access pattern MAP3′ and the marker MK, and the n-th PASQ entry 30n′ may include an n-th memory access pattern MAPn′ and the marker MK.

Referring to FIGS. 2 and 3B, when the amount of data or a data size needed for a neural network operation is not clear, each of the PASQ entries 30a′ to 30n′ may include the marker MK, which specifies a process for updating the prefetch count PF_CNT, and moreover, the DMA engine 101 may include a marker which specifies a process for updating the demand count DM_CNT. For example, each of the PASQ entries 30a′ to 30n′ may include a first marker, and the DMA engine 101 may include a second marker. In an embodiment, the first and second markers may be dynamically changed. In an embodiment, the first and second markers may have different values. In an embodiment, the first and second markers may have the same value.

When DMA or prefetch reaches the marker MK, a progress value may be updated to a corresponding value. Therefore, when it is determined that the DMA engine 101 may not prefetch a certain amount of data, the DMA engine 101 may update the demand count DM_CNT to an arbitrary large value. Accordingly, the prefetch module 102 may drop all prefetch requests until the prefetch count PF_CNT reaches another marker which may be updated to match the demand count DM_CNT.

Referring again to FIG. 2, the controller 102b may generate the prefetch request REQ_PF based on the memory access pattern MAP queued in the access sequence queue 102a. Data may be prefetched from a memory, based on the prefetch request REQ_PF. Also, the controller 102b may generate the prefetch count PF_CNT or a prefetch issue count representing the number of times that the prefetch request REQ_PF is issued. For example, the controller 102b may increase or increment the prefetch count PF_CNT whenever the prefetch request REQ_PF is issued or the prefetch request REQ_PF is dropped.

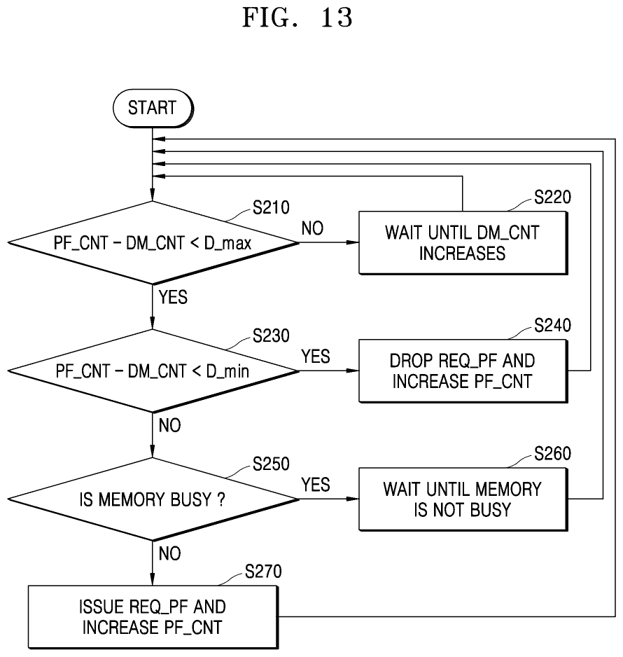

The controller 102b may compare the prefetch request REQ_PF to the demand count DM_CNT and may control a prefetch operation based on a comparison result (e.g., based on a result of the comparing). In an embodiment, when there is no immediate demand request REQ_DM, and a value obtained by subtracting the demand count DM_CNT from the prefetch count PF_CNT is less than a first distance (e.g., a maximum distance such as the maximum distance D_max of FIG. 13), the controller 102b may issue the prefetch request REQ_PF and may increase or increment the prefetch count PF_CNT. In this case, an operation may be performed to determine whether the immediate demand request REQ_DM has been issued in order to prevent a collision between the demand request REQ_DM and the prefetch request REQ_PF. The demand request REQ_DM may be higher in priority than the prefetch request REQ_PF, and thus, when there is no immediate demand request REQ_DM, the prefetch request REQ_PF may be issued.

In an embodiment, when the value obtained by subtracting the demand count DM_CNT from the prefetch count PF_CNT is not less than the first distance, it may be determined that a progress of a prefetch operation is fast. As a result, the controller 102b may stop the issue of the prefetch request REQ_PF (e.g., refrain from issuing the prefetch request REQ_PF) until the demand count DM_CNT increases or increments. In this case, the first distance may correspond to a maximum distance based on an available size of the system cache 120 and may be dynamically reconfigured. For example, the maximum distance may be a parameter which controls how fast the controller 102b issues the prefetch request REQ_PF. For example, the maximum distance may be stored in a register of the controller 102b. For example, the maximum distance may correspond to the maximum available distance of the system cache 120 and may correspond to an available size of the NPU 100 on the system cache 120 when the other elements do not use the system cache 120.

In an embodiment, when the value obtained by subtracting the demand count DM_CNT from the prefetch count PF_CNT is less than a second distance (e.g., a minimum distance such as the minimum distance D_min of FIG. 13) which is less than the first distance, it may be determined that a progress of a prefetch operation is slow. As a result, the controller 102b may drop the prefetch request REQ_PF and may increase or increment the prefetch count PF_CNT. In this case, the second distance may correspond to a minimum distance based on an available size of the system cache 120 and may be dynamically reconfigured. For example, the minimum distance may be stored in the register of the controller 102b.

FIG. 4 is a block diagram illustrating an electronic device 40 according to an embodiment.

Referring to FIG. 4, the electronic device 40 may include a system-on-chip 10a and a memory 110. The system-on-chip 10a may include an NPU 100a, a system cache 120, a CPU 130a, a memory controller 150, and a system bus 140a. At least one of the NPU 100a, the system cache 120, the CPU 130a, and the memory controller 150 may communicate with each other using the system bus 140a. The memory 110 may be implemented as an off-chip memory which is disposed outside the system-on-chip 10a. For example, the memory 110 may be implemented as a DRAM chip, but embodiments are not limited thereto.

The NPU 100a may include a DMA engine 101, a prefetch module 102, a compute unit 103, and a buffer 104. The buffer 104 may be a buffer memory having a storage capacity which is less than that of the system cache 120. For example, the buffer 104 may include an SRAM buffer, but embodiments are not limited thereto. The NPU 100a may perform a neural network operation in response to an instruction (e.g., the instruction IN of FIG. 2) received from the CPU 130a.

The system bus 140a may correspond to an example of the interface 140 of FIG. 1. In an embodiment, the system bus 140a may be implemented in a network-on-chip (NoC) scheme. The NoC scheme may be a scheme which applies packet or circuit network technology between a general computer or a communication device to connect processing circuits of a semiconductor chip with each other. The system bus 140a may include a router and a switching circuit in order to provide a transfer path of each of data and a signal between processing circuits (e.g., the CPU 130a, the NPU 100a), the system cache 120, and the memory controller 150 of the system-on-chip 10a.

In an embodiment, the system bus 140a may be implemented as an NoC type to which a protocol having certain norm bus standard is applied. For example, advanced microcontroller bus architecture (AMBA) protocol of Advanced RISC Machine (ARM) may be applied as norm bus standard. A bus type of the AMBA protocol may include advanced high-performance bus (AHB), advanced peripheral bus (APB), advanced extensible interface (AXI), AX14, and AXI coherency extensions (ACE). AXI among the bus types described above may be an interface protocol between function blocks and may provide a multiple outstanding address function and a data interleaving function. In addition, protocols of other types of protocols such as uNetwork of SONICs Inc., CoreConnect of IBM, and open core protocol of OCP-IP may be applied to the system bus 140a.

The system bus 140a may receive a memory access request from some elements (e.g., the CPU 130a and the NPU 100a) of the system-on-chip 10a and may transfer an access request to an element (e.g., the system cache 120 or the memory 110) having a corresponding access address, based on a physical address or a virtual address (e.g., an access address) included in the memory access request. Also, the system bus 140a may transfer a response to the memory access request to an element which has provided the access request.

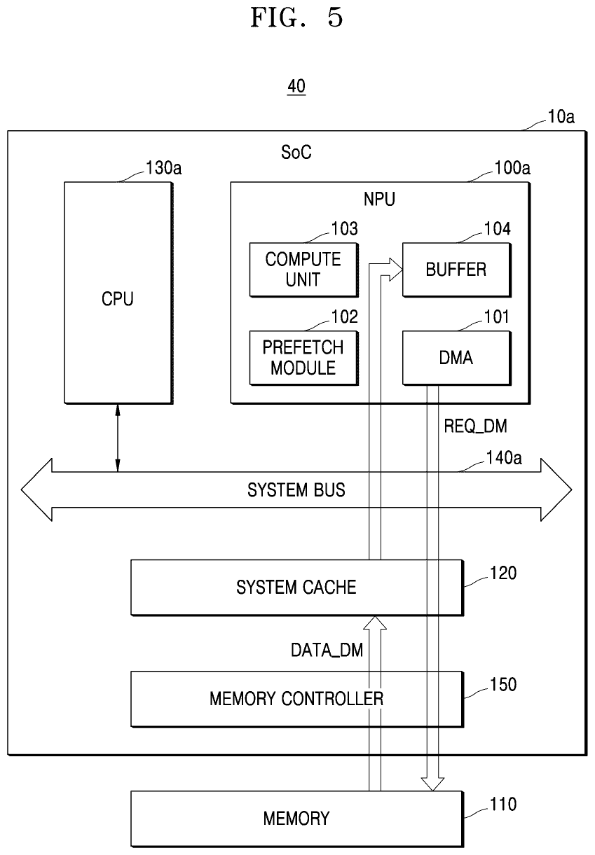

FIG. 5 illustrates a DMA operation based on the demand request REQ_DM of the electronic device 40 of FIG. 4, according to an embodiment.

Referring to FIG. 5, a DMA engine 101 may issue a demand request REQ_DM for demand data corresponding to a neural network operation. The system bus 140a may transfer the demand request REQ_DM to a memory controller 150. The memory controller 150 may generate an address and a read command for controlling a read operation on the memory 110, in response to the demand request REQ_DM. The memory 110 may output demand data DATA_DM corresponding to the demand request REQ_DM, in response to the read command and the address each received from the memory controller 150. The system cache 120 may store the demand data DATA_DM received from the memory 110. The system bus 140a may transfer the demand data DATA_DM, received from the system cache 120, to an NPU 100a. The NPU 100a may load the received demand data DATA_DM into the buffer 104. The compute unit 103 may perform the neural network operation on the demand data DATA_DM loaded into the buffer 104.

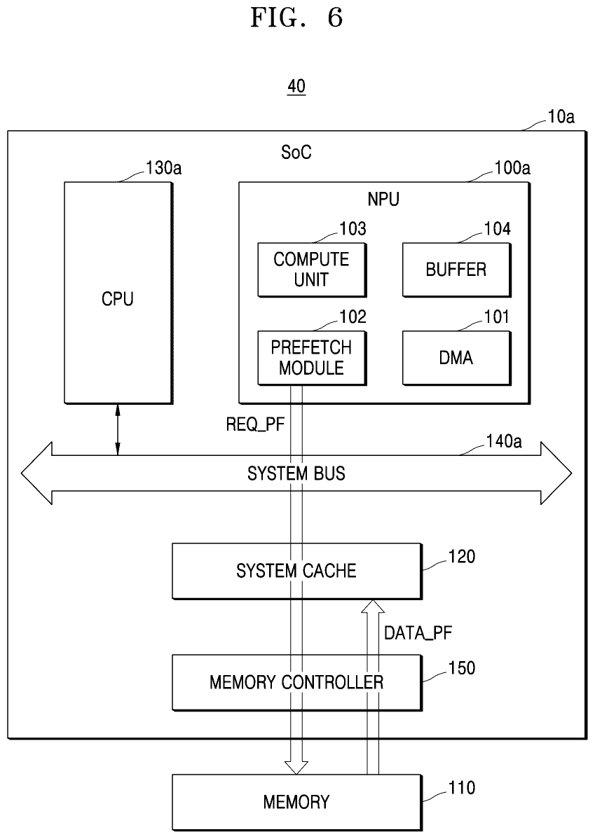

FIG. 6 illustrates a prefetch operation based on the prefetch request REQ_PF of the electronic device 40 of FIG. 4, according to an embodiment.

Referring to FIG. 6, the prefetch module 102 may issue a prefetch request REQ_PF to prefetch data based on a memory access pattern predicted according to a neural network operation. A system bus 140a may transfer the prefetch request REQ_PF to a memory controller 150. The memory controller 150 may generate an address and a read command for controlling a read operation on the memory 110, in response to the prefetch request REQ_PF. The memory 110 may output prefetch data DATA_PF corresponding to the prefetch request REQ_PF, in response to the read command and the address each received from the memory controller 150. The system cache 120 may store, as data DATA, the prefetch data DATA_PF received from the memory 110. As described above, the data DATA received in response to the prefetch request REQ_PF may be previously loaded into the system cache 120.

Subsequently, based on the DMA engine 101 issuing a demand request REQ_DM corresponding to the neural network operation, the system bus 140a may transfer the prefetch data DATA_PF corresponding to the prefetch request REQ_PF from the system cache 120 to the NPU 100a. The NPU 100a may load the received prefetch data DATA_PF into the buffer 104. The compute unit 103 may perform the neural network operation on the prefetch data DATA_PF loaded into the buffer 104. As described above, the prefetch data DATA_PF may be prefetched in the system cache 120 using a prefetch operation, and thus, when the demand request REQ_DM is actually issued, the NPU 100a may receive data from the system cache 120 without accessing the memory 110. Accordingly, the operation speed of the NPU 100a may be more enhanced, and thus, the performance of the system-on-chip 10a may be enhanced.

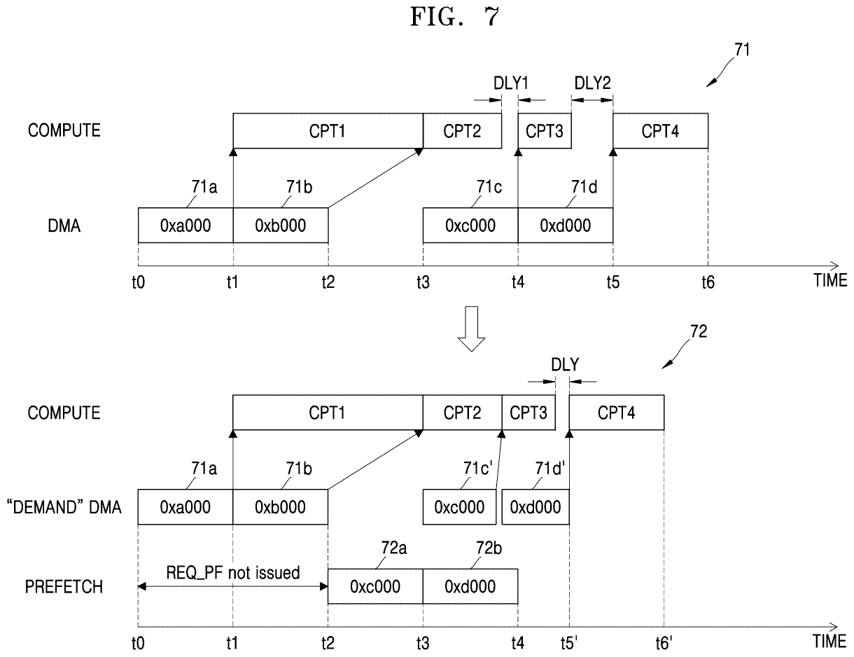

FIG. 7 illustrates example operations of a system-on-chip including a DMA operation and a prefetch operation, according to an embodiment.

Referring to FIGS. 4 and 7, a process 71 in which a prefetch operation is not performed may include a plurality of DMA operations (e.g., a first DMA operation 71a, a second DMA operation 71b, a third DMA operation 71c, and a fourth DMA operation 71d), and may also include a corresponding plurality of compute operations (e.g., a first compute operation CPT1, a second compute operation CPT2, a third compute operation CPT3, and a fourth compute operation CPT4). According to embodiments, the first to fourth DMA operations 71a to 71d may be sequentially performed, and thus, the first to fourth compute operations CPT1 to CPT4 may be sequentially performed. For example, the first to fourth DMA operations 71a to 71d may be performed in the DMA engine 101, the system cache 120, and the memory 110. For example, the first to fourth compute operations CPT1 to CPT4 may be performed in the compute unit 103.

The first DMA operation 71a may start at a time t0 and may end at a time t1, and for example, a memory access operation (e.g., a read operation) corresponding to an address 0xa000 may be performed. As a result of performing the first DMA operation 71a, data stored in the memory 110 or the system cache 120 may be loaded into the buffer 104 of the NPU 100a. When the first DMA operation 71a ends at the time t1, the first compute operation CPT1 may be performed. For example, the compute unit 103 may perform a neural network operation on the data loaded into the buffer 104. For example, the first compute operation CPT1 may be performed from the time t1 to a time t3.

Subsequently, the second DMA operation 71b may start at the time t1 and may end at a time t2, and for example, a memory access operation (e.g., a read operation) corresponding to an address 0xb000 may be performed. As a result of performing the second DMA operation 71b, data stored in the memory 110 or the system cache 120 may be loaded into the buffer 104 of the NPU 100a. When the first compute operation CPT1 ends at the time t3, the second compute operation CPT2 may be performed. For example, the compute unit 103 may perform a neural network operation on the data loaded into the buffer 104.

When there is insufficient space in the buffer 104 of the NPU 100a due to the first and second DMA operations 71a and 71b, the third DMA operation 71c may not immediately start despite the end of each of the first and second DMA operations 71a and 71b. Then, the third DMA operation 71c may start at the time t3 and may end at a time t4, and for example, a memory access operation (e.g., a read operation) corresponding to an address 0xc000 may be performed. After the third DMA operation 71c ends at the time t4, the third compute operation CPT3 may be performed. Then, as the third DMA operation 71c is performed, a first delay DLY1 may occur between the second compute operation CPT2 and the third compute operation CPT3. The fourth DMA operation 71d may start at the time t4 and may end at a time t5, and for example, a memory access operation (e.g., a read operation) corresponding to an address 0xd000 may be performed. When the fourth DMA operation 71d ends at the time t5, the fourth compute operation CPT4 may be performed. Then, as the fourth DMA operation 71d is performed, a second delay DLY2 may occur between the third compute operation CPT3 and the fourth compute operation CPT4.

In contrast, a process 72 of the system-on-chip in which a prefetch operation is performed may include a plurality of DMA operations (e.g., the first DMA operation 71a, the second DMA operation 71b, a third DMA operation 71c′, and a fourth DMA operation 71d′) and a plurality of prefetch operations (e.g., a first prefetch operation 72a and a second prefetch operation 72b), and may also include a corresponding plurality of compute operations (e.g., a first compute operation CPT1, a second compute operation CPT2, a third compute operation CPT3, and a fourth compute operation CPT4). According to embodiments, based on the first and second DMA operations 71a and 71b being sequentially performed, the first and second prefetch operations 72a and 72b may be sequentially performed according to a memory access pattern based on the first and second DMA operations 71a and 71b. For example, the first and second compute operations CPT1 and CPT2 respectively corresponding to the first and second DMA operations 71a and 71b may be performed, and then, the third and fourth compute operations CPT3 and CPT4 respectively corresponding to third and fourth DMA operations 71c′ and 71d′ may be performed.

For example, the first to fourth DMA operations 71a to 71d′ may be performed in the DMA engine 101, the system cache 120, and the memory 110. In this case, in order to be distinguished from the first and second prefetch operations 72a and 72b, the first to fourth DMA operations 71a to 71d′ may be referred to as demand DMA operations. For example, the first and second prefetch operations 72a and 72b may be performed in the prefetch module 102, the system cache 120, and the memory 110. For example, the first to fourth compute operations CPT1 to CPT4 may be performed in the compute unit 103.

While the first and second prefetch operations 72a and 72b are being performed, a prefetch request REQ_PF may not be issued. As described above, a demand request REQ_DM may be higher in priority than the prefetch request REQ_PF (e.g., a priority of the demand request REQ_DM may be higher than a priority of the prefetch request REQ_PF). For example, the prefetch request REQ_PF may be lower in priority than the demand request REQ_DM (e.g., a priority of the prefetch request REQ_PF may be lower than a priority of the demand request REQ_DM). While a DMA operation based on the demand request REQ_DM is being performed, a memory system including the memory 110 may be busy, and thus, the prefetch request REQ_PF may not be issued, and therefore a prefetch operation may not be performed. However, even in this case, a prefetch count PF_CNT may increase.

Based on a memory access pattern (e.g., 0xa000 and 0xb000) of each of the first and second DMA operations 71a and 71b, the prefetch module 102 may predict a next memory access pattern (e.g., 0xc000 and 0xd000) and may store the predicted memory access pattern in an access sequence queue (e.g., the access sequence queue 102a of FIG. 2). The first prefetch operation 72a may start at the time t2 and may end at the time t3, and for example, a memory access operation (e.g., a read operation) corresponding to an address 0xc000 may be performed. As a result of performing the first prefetch operation 72a, data stored in the memory 110 may be loaded into the system cache 120. The second prefetch operation 72b may start at the time t3 and may end at the time t4, and for example, a memory access operation (e.g., a read operation) corresponding to an address 0xd000 may be performed. As a result of performing the second prefetch operation 72b, data stored in the memory 110 may be loaded into the system cache 120.

The third DMA operation 71c′ may start at the time t3 and may end before the time t4. The third DMA operation 71c′ may be, for example, a memory access operation corresponding to an address 0xc000, and because the first prefetch operation 72a on a corresponding address is previously performed, data corresponding to the corresponding address may be previously loaded into the system cache 120. Accordingly, the third DMA operation 71c′ may receive data from the system cache 120 without accessing the memory 110, and thus, a time consumed by this operation may be less than an operation for which a prefetch operation is not performed (e.g., a time consumed by the operation 71c′ may be less than a time consumed by the operation 71c). As a result of performing the third DMA operation 71c′, data stored in the system cache 120 may be loaded into the buffer 104 of the NPU 100a. When the third DMA operation 71c′ ends, the third compute operation CPT3 may be performed, and thus, a delay between the second compute operation CPT2 and the third compute operation CPT3 may be removed or reduced.

The fourth DMA operation 71d′ may start before the time t4 and may end at a time t5′, and in this case, the time t5′ may be a time which is earlier than the time t5. The fourth DMA operation 71d′ may be, for example, a memory access operation corresponding to an address 0xd000, and because the second prefetch operation 72b on a corresponding address is previously performed, data corresponding to the corresponding address may be previously loaded into the system cache 120. Accordingly, the fourth DMA operation 71d′ may receive data from the system cache 120 without accessing the memory 110, and thus, a time consumed by this operation may be less than an operation for which a prefetch operation is not performed (e.g., a time consumed by the operation 71d′ may be less than a time consumed by the operation 71d). As a result of performing the fourth DMA operation 71d′, data stored in the system cache 120 may be loaded into the buffer 104 of the NPU 100a. When the fourth DMA operation 71d′ ends, the fourth compute operation CPT4 may be performed, and thus, a delay DLY between the third compute operation CPT3 and the fourth compute operation CPT4 may be reduced more than the second delay DLY2. Also, the fourth compute operation CPT4 may end at a time t6′, and in this case, the time t6′ may be earlier than the time t6.

The DMA engine 101 may increase or increment the demand count DM_CNT whenever the demand request REQ_DM is issued. Therefore, in an embodiment, the demand count DM_CNT generated by the DMA engine 101 may have a value of four (“4”). Furthermore, the prefetch module 102 may increase or increment the prefetch count PF_CNT whenever the prefetch request REQ_PF is issued or the prefetch request REQ_PF is dropped. Accordingly, in an embodiment, the prefetch count PF_CNT generated by the prefetch module 102 may have a value of four (“4”).

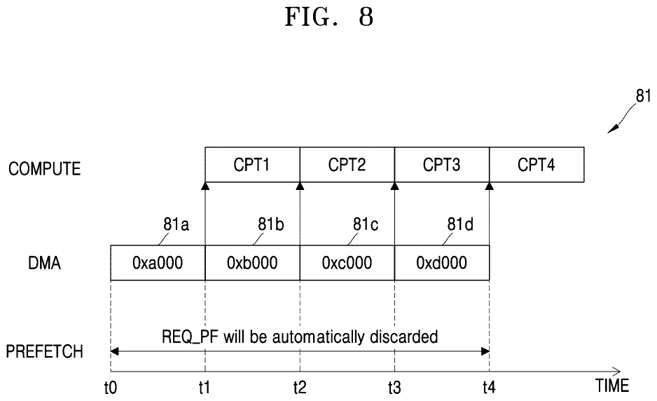

FIG. 8 illustrates example operations of a system-on-chip including a DMA operation and a prefetch operation, according to an embodiment.

Referring to FIGS. 4 and 8, a process 81 of the system-on-chip according to an embodiment may include a plurality of DMA operations (e.g., a first DMA operation 81a, a second DMA operation 81b, a third DMA operation 81c, and a fourth DMA operation 81d), and may also include a corresponding plurality of compute operations (e.g., a first compute operation CPT1, a second compute operation CPT2, a third compute operation CPT3, and a fourth compute operation CPT4). According to embodiments, the first to fourth DMA operations 81a to 81d may be sequentially performed, and thus, the first to fourth compute operations CPT1 to CPT4 may be sequentially performed. For example, the first to fourth DMA operations 81a to 81d may be performed in the DMA engine 101, the system cache 120, and the memory 110. For example, the first to fourth compute operations CPT1 to CPT4 may be performed in the compute unit 103.

For example, the first DMA operation 81a may start at a time t0 and may end at a time t1, and the first compute operation CPT1 may start at the time t1. For example, the second DMA operation 81b may start at the time t1 and may end at a time t2, and the second compute operation CPT2 may start at the time t2. For example, the third DMA operation 81c may start at the time t2 and may end at a time t3, and the third compute operation CPT3 may start at the time t3. For example, the fourth DMA operation 81d may start at the time t3 and may end at a time t4, and the fourth compute operation CPT4 may start at the time t4.

In an embodiment, based on the DMA engine 101 sequentially issuing a plurality of demand requests REQ_DM, the first to fourth DMA operations 81a to 81d may be sequentially performed. At this time, a demand count DM_CNT generated by the DMA engine 101 may have a value of four (“4”). As described above, when the plurality of demand requests REQ_DM are continuously issued, the plurality of demand requests REQ_DM may be higher in priority than a prefetch request REQ_PF, and thus, the prefetch request REQ_PF may be automatically discarded. In addition, due to the plurality of demand requests REQ_DM, when a memory system including the memory 110 is busy, the prefetch request REQ_PF may be automatically discarded.

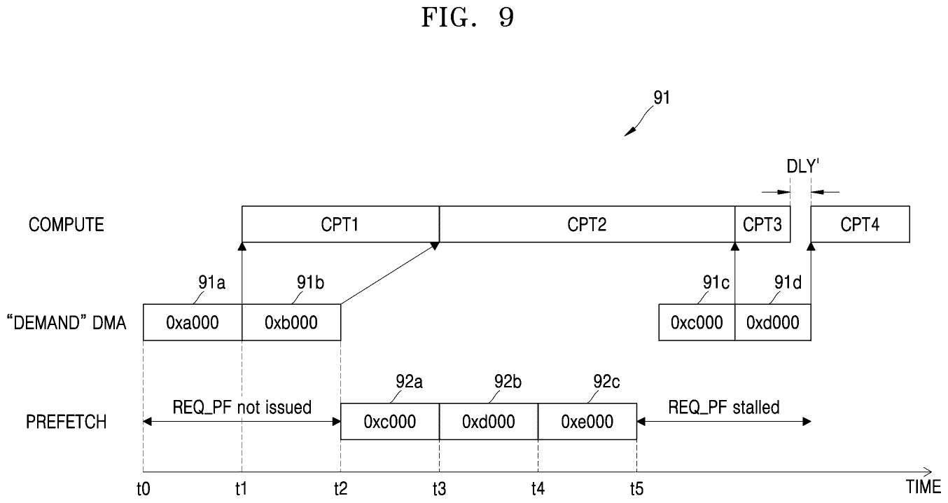

FIG. 9 illustrates example operations of a system-on-chip including a DMA operation and a prefetch operation, according to an embodiment.

Referring to FIGS. 4 and 9, a process 91 of the system-on-chip may include a plurality of DMA operations (e.g., a first DMA operation 91a, a second DMA operation 91b, a third DMA operation 91c, and a fourth DMA operation 91d), and a plurality of prefetch operation (e.g., a first prefetch operation 92a, a second prefetch operation 92b, and a third prefetch operation 92c), and may also include a corresponding plurality of compute operations (e.g., a first compute operation CPT1, a second compute operation CPT2, a third compute operation CPT3, and a fourth compute operation CPT4). According to an embodiment, after first and second DMA operations 91a and 91b are sequentially performed, first to third prefetch operations 92a to 92c may be sequentially performed according to a memory access pattern based on the first and second DMA operations 91a and 91b. For example, first and second compute operations CPT1 and CPT2 respectively corresponding to the first and second DMA operations 91a and 91b may be performed.

According to embodiments, when the consumption time of the second compute operation CPT2 increases considerably, the start time of a third DMA operation 91c may be delayed. When prefetch operations are continuously performed before the third DMA operation 91c starts, prefetch data read from the memory 110 using a prefetch operation may be continuously stored in the system cache 120, and thus, the capacity of system cache 120 may be insufficient. Accordingly, when a threshold or more amount of data is stored in the system cache 120 by a prefetch operation, the prefetch module 102 may stop the issue of a prefetch request REQ_PF (e.g., refrain from issuing a prefetch request REQ_PF), and thus, the prefetch operation may no longer be performed.

For example, first to fourth DMA operations 91a to 91d may be performed in the DMA engine 101, the system cache 120, and the memory 110. For example, the first to third prefetch operations 92a to 92c may be performed in the prefetch module 102, the system cache 120, and the memory 110. For example, the first to fourth compute operations CPT1 to CPT4 may be performed in the compute unit 103.

While the first and second DMA operations 91a and 91b are being performed, the prefetch request REQ_PF may not be issued. As described above, a demand request REQ_DM may be higher in priority than the prefetch request REQ_PF. For example, the prefetch request REQ_PF may be lower in priority than the demand request REQ_DM. While a DMA operation based on the demand request REQ_DM is being performed, a memory system including the memory 110 may be busy, and thus, the prefetch request REQ_PF may not be issued, and therefore a prefetch operation may not be performed.

Based on a memory access pattern (e.g., 0xa000 and 0xb000) of each of the first and second DMA operations 91a and 91b, the prefetch module 102 may predict a next memory access pattern (e.g., 0xc000, 0xd000, and 0xe000) and may store the predicted memory access pattern in an access sequence queue (e.g., the access sequence queue 102a of FIG. 2). The first prefetch operation 92a may start at a time t2 and may end at a time t3, and for example, a memory access operation (e.g., a read operation) corresponding to an address 0xc000 may be performed. The second prefetch operation 92b may start at the time t3 and may end at a time t4, and for example, a memory access operation (e.g., a read operation) corresponding to an address 0xd000 may be performed. The third prefetch operation 92c may start at the time t4 and may end at a time t5, and for example, a memory access operation (e.g., a read operation) corresponding to an address 0xe000 may be performed.

Subsequently, the third and fourth DMA operations 91c and 91d may be performed, and third and fourth compute operations CPT3 and CPT4 respectively corresponding to the third and fourth DMA operations 91c and 91d may be performed. The third DMA operation 91c may be, for example, a memory access operation corresponding to an address 0xc000, and because the first prefetch operation 92a on a corresponding address is previously performed, data corresponding to the corresponding address may be previously loaded into the system cache 120. Accordingly, the third DMA operation 91c may receive data from the system cache 120 without accessing the memory 110, and thus, a time consumed by this operation may be less than an operation for which a prefetch operation is not performed. When the third DMA operation 91c ends, the third compute operation CPT3 may be performed, and thus, a delay between the second compute operation CPT2 and the third compute operation CPT3 may be removed or reduced.

The fourth DMA operation 91d may be, for example, a memory access operation corresponding to an address 0xd000, and because the second prefetch operation 92b on a corresponding address is previously performed, data corresponding to the corresponding address may be previously loaded into the system cache 120. Accordingly, the fourth DMA operation 91d may receive data from the system cache 120 without accessing the memory 110, and thus, a time consumed by this operation may be less than an operation for which a prefetch operation is not performed. When the fourth DMA operation 91d ends, the fourth compute operation CPT4 may be performed, and thus, a delay DLY′ between the third compute operation CPT3 and the fourth compute operation CPT4 may be reduced to be less than the second delay DLY2 discussed above.

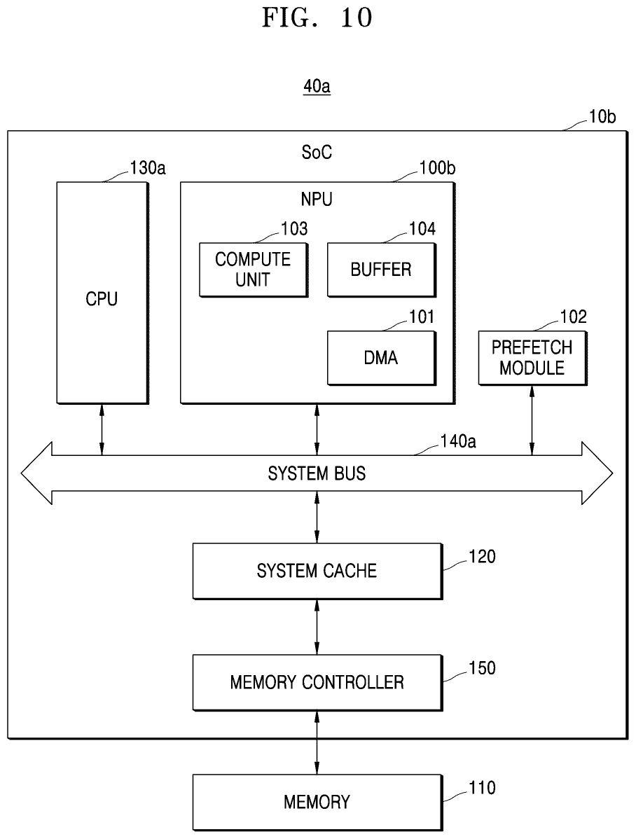

FIG. 10 is a block diagram illustrating an electronic device 40a according to an embodiment.

Referring to FIG. 10, the electronic device 40a may include a system-on-chip 10b and a memory 110. The system-on-chip 10b according to an embodiment may correspond to a modified example of the system-on-chip 10a of FIG. 4, and relevant description given above with reference to FIGS. 4 to 9 may be applied to the example illustrated in FIG. 10. The system-on-chip 10b may include an NPU 100b, a prefetch module 102, a system cache 120, a CPU 130a, the memory controller 150, and the system bus 140a. At least one of the NPU 100b, the prefetch module 102, the system cache 120, the CPU 130a, and the memory controller 150 may communicate with each other using the system bus 140a. As described above, according to an embodiment, the prefetch module 102 may be disposed outside the NPU 100b. The memory 110 may be implemented as an off-chip memory which is disposed outside the system-on-chip 10b. For example, the memory 110 may be implemented as a DRAM chip, but embodiments are not limited thereto.

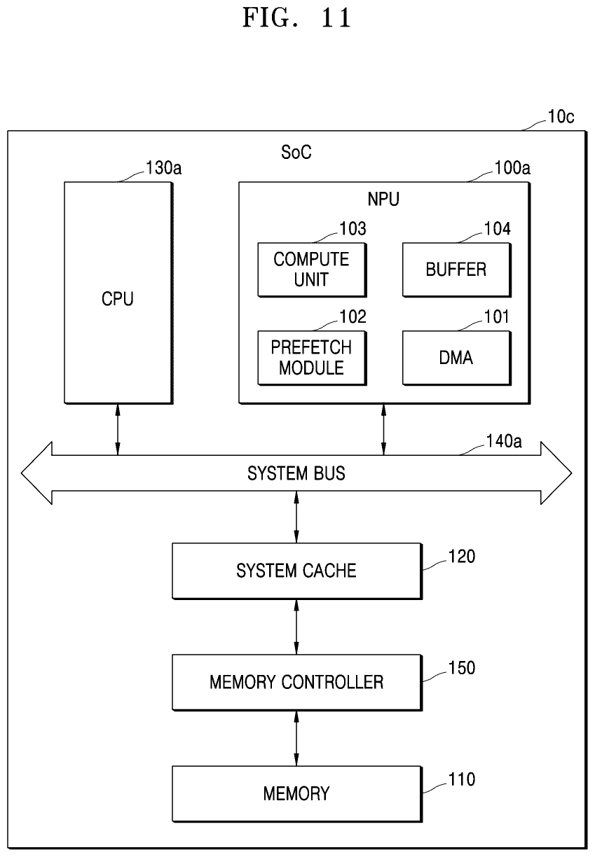

FIG. 11 is a block diagram illustrating a system-on-chip 10c according to an embodiment.

Referring to FIG. 11, the system-on-chip 10c may correspond to a modified example of the system-on-chip 10a of FIG. 4 or the system-on-chip 10b of FIG. 10, and relevant description given above with reference to FIGS. 4 to 10 may be applied to the example shown in FIG. 11. The system-on-chip 10c may include an NPU 100a, a system cache 120, a CPU 130a, the memory controller 150, the system bus 140a, and a memory 110. The NPU 100a, the prefetch module 102, the system cache 120, the CPU 130a, the memory controller 150, and the memory 110 may communicate with each other using the system bus 140a. As described above, according to an embodiment, the memory 110 may be implemented as an on-chip-memory which is disposed in the system-on-chip 10c. For example, the memory 110 may be implemented as DRAM, but embodiments are not limited thereto.

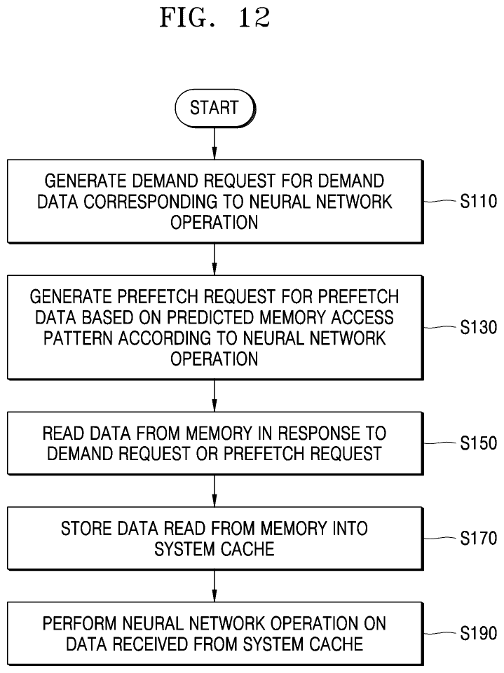

FIG. 12 is a flowchart illustrating a process for operating a system-on-chip, according to an embodiment.

Referring to FIG. 12, the process for operating a system-on-chip may correspond to a method which performs a data prefetch operation based on a memory access pattern to enhance the performance of an accelerator, and for example, may include operations which are time-serially performed in the electronic device 10 of FIG. 1, the system-on-chip 10a of FIG. 4, the system-on-chip 10b of FIG. 10, or the system-on-chip 10c of FIG. 11. Hereinafter, examples of processes for operating a system-on-chip are described with reference to FIGS. 4 and 12.

At operation S110, a demand request for demand data corresponding to a neural network operation may be generated. For example, the DMA engine 101 may generate a demand request for reading, from the memory 110 or the system cache 120, demand data for performing the neural network operation, in response to an instruction received from a host processor (e.g., the CPU 130a).

At operation S130, a prefetch request for prefetch data may be generated based on a memory access pattern predicted according to the neural network operation. For example, the prefetch module 102 may receive the memory access pattern from the DMA engine 101 and may store the received memory access pattern in an access sequence queue. In the neural network operation, based on a memory access sequence being previously known, a prefetch operation may be performed based on a situation of the memory 110 or a memory system. For example, the prefetch module 102 may issue or drop the prefetch request, based on an issue situation of a demand request and the situation of the memory system.

At operation S150, data may be read from the memory 110 in response to the demand request or the prefetch request. For example, the memory controller 150 may generate a read command and an address in response to the demand request or the prefetch request, and may transfer the generated read command and address to the memory 110. For example, the memory 110 may perform a read operation on data corresponding to the address in order to output corresponding data, in response to the read command.

In an embodiment, before operation S150, in response to the demand request, an operation of checking whether data corresponding to a corresponding address is stored in the system cache 120 may be added. When the data corresponding to the corresponding address is stored in the system cache 120, a read operation on the memory 110 may not be performed, and the data stored in the system cache 120 may be loaded into the buffer 104 of the NPU 100a. For example, based on the prefetch operation, data may be previously stored in the system cache 120, and an access time of the memory 110 may be reduced.

At operation S170, the data read from the memory 110 (e.g., read data) may be stored in the system cache 120. For example, the memory controller 150 may store the data, read from the memory 110, in the system cache 120. In an embodiment, when a memory read operation based on the demand request is performed, an operation of loading the data, stored in the system cache 120, into the buffer 104 of the NPU 100a may be further performed after operation S170. At operation S190, the neural network operation on the data received from the system cache 120 may be performed. For example, the compute unit 103 of the NPU 100a may perform the neural network operation (e.g., a matrix operation or a convolution operation) on the data loaded into the buffer 104.

FIG. 13 is a flowchart illustrating a process for operating a system-on-chip, according to an embodiment.

Referring to FIG. 13, the process for operating a system-on-chip may correspond to a modified example of operation S130 included in the process illustrated in FIG. 12, and for example, may include operations which are time-serially performed in the electronic device 10 of FIG. 1, the system-on-chip 10a of FIG. 4, the system-on-chip 10b of FIG. 10, or the system-on-chip 10c of FIG. 11. Hereinafter, an example of a process for operating a system-on-chip is described with reference to FIGS. 4 and 13.

At operation S210, the process may include determining whether a difference value obtained by subtracting a demand count DM_CNT from a prefetch count PF_CNT is less than a first value (e.g., a maximum distance D_max). Here, the maximum distance D_max may be dynamically determined based on the maximum available capacity of the system cache 120. Based on determining that the difference value is less than the maximum distance D_max (YES at operation S210), operation S230 may be performed Based on determining that the difference value is greater than or equal to the maximum distance D_max (NO at operation S210), the process may proceed to operation S220, in which a standby operation may be performed until the demand count DM_CNT increases or increments.

At operation S230, the process may include determining whether the difference value obtained by subtracting the demand count DM_CNT from the prefetch count PF_CNT is less than a second value (e.g., a minimum distance D_min) which is less than the first value. Based on determining that the difference value is not less than (e.g., is greater than or equal to) the minimum distance D_min (NO at operation S230), operation S250 may be performed. Based on determining that the difference value is less than the minimum distance D_min (YES at operation S230), the process may proceed to operation S240, in which a prefetch request REQ_PF may be dropped, and the prefetch count PF_CNT may increase.

At operation S250, the process may include determining whether a memory is busy may be determined. Based on determining that the memory is not busy (e.g., the memory is idle) (NO at operation S250), the process may proceed to operation S270, in which the prefetch request REQ_PF may be issued, and the prefetch count PF_CNT may be increased or incremented. Based on determining that the memory is busy (YES at operation S250), the process may proceed to operation S260, in which a standby operation may be performed until the memory is not busy (e.g., until the memory is idle).

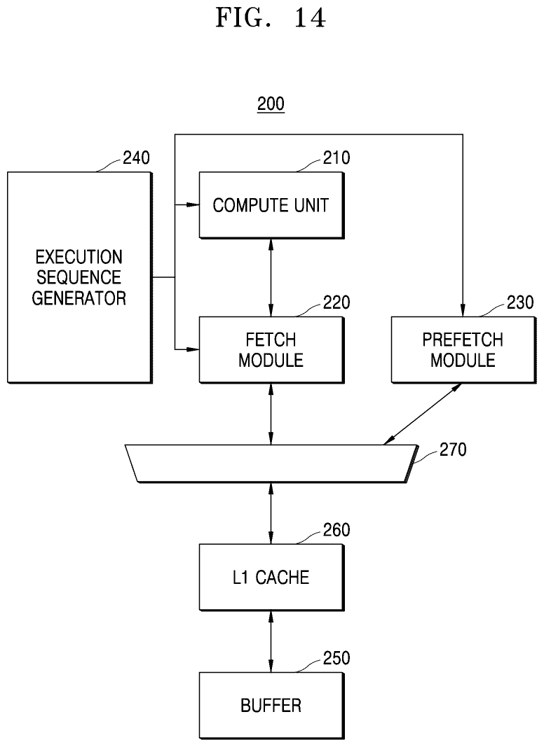

FIG. 14 is a block diagram illustrating an accelerator 200 according to an embodiment.

Referring to FIG. 14, the accelerator 200 may perform a task corresponding to an instruction received from a host processor and may include a compute unit 210, a fetch unit or fetch module 220, a prefetch unit or prefetch module 230, an execution sequence generator 240, a buffer memory or buffer 250, a cache memory 260, and an interface 270. As shown in FIG. 14, in some embodiments the cache memory 260 may be, or may include, a Level 1 (L1) cache, but embodiments are not limited thereto.

In an embodiment, the accelerator 200 may correspond to a processing unit (e.g., an NPU, a GPU, a CPU, or a TPU). However, embodiments are not limited thereto, and in some embodiments, the accelerator 200 may be implemented using at least one of a combination logic, a sequential logic, one or more timers, a counter, a register, a state machine, a CPLD, an FPGA, an ASIC, a CPU such as a CISC processor such as an x86 processor and/or a RISC processor such as an ARM processor, and any combination thereof. Therefore, the DMA operation and the prefetch operation described above with reference to FIGS. 1 to 13 may be applied to the example shown in FIG. 14.

The execution sequence generator 240 may dispatch arithmetic operations used to perform a task corresponding to an instruction received from a host processor. For example, the arithmetic operations may include at least one of a matrix operation and a convolution operation. The matrix operation and the convolution operation may correspond to a previously known memory access pattern (e.g., a predetermined memory access pattern), and thus, a prefetch operation of prefetching data from the buffer 250 to the cache memory 260 by using the memory access pattern may be performed.

The fetch module 220 may generate a demand request corresponding to demand data which is data corresponding to the arithmetic operation. The prefetch module 230 may generate a prefetch request to prefetch data, based on the memory access pattern corresponding to the arithmetic operation. In an embodiment, the prefetch module 230 may include a queue which stores the memory access pattern and a controller which generates the prefetch request. The memory access pattern may be previously determined based on the arithmetic operation, and may include a memory read pattern and a memory write pattern each corresponding to the demand request generated by the fetch module 220. In this case, the demand request may be higher in priority than the prefetch request. Therefore, when the demand request is continuously issued, and thus, a memory or a memory system is busy, the prefetch request may not be issued.

In an embodiment, the fetch module 220 may generate a demand count corresponding to the number of times that the demand request is issued, and the prefetch module 230 may generate a prefetch count corresponding to the number of times that the prefetch request is issued. In an embodiment, when the buffer 250 is idle, the prefetch module 230 may issue the prefetch request, and thus, the prefetch data may be transferred to the cache memory 260. In an embodiment, when the buffer 250 is busy, the prefetch module 230 may delete the prefetch request.

The interface 270 may transfer, to the buffer 250, the demand request generated by the fetch module 220 or the prefetch request generated by the prefetch module 230. The buffer 250 may store demand data or prefetch data. For example, the buffer 250 may store the demand data or the prefetch data received from a memory (e.g., the memory 110 of FIG. 1) or a system cache (e.g., the system cache 120 of FIG. 1) outside the accelerator 200. For example, the buffer 250 may be a high-speed SRAM buffer, which has less capacity than the memory 110 or the system cache 120.

The cache memory 260 may receive the demand data or the prefetch data from the buffer 250 and may store the received data. For example, the cache memory 260 may be a high-speed cache memory, which has less capacity than the buffer 250. The compute unit 210 may perform an arithmetic operation on the data stored in the cache memory 260. In this case, the cache memory 260 may be disposed between the compute unit 210 and the buffer 250, and the compute unit 210 may perform an arithmetic operation on the data stored in the cache memory 260 disposed close thereto, thereby further enhancing an operation speed.

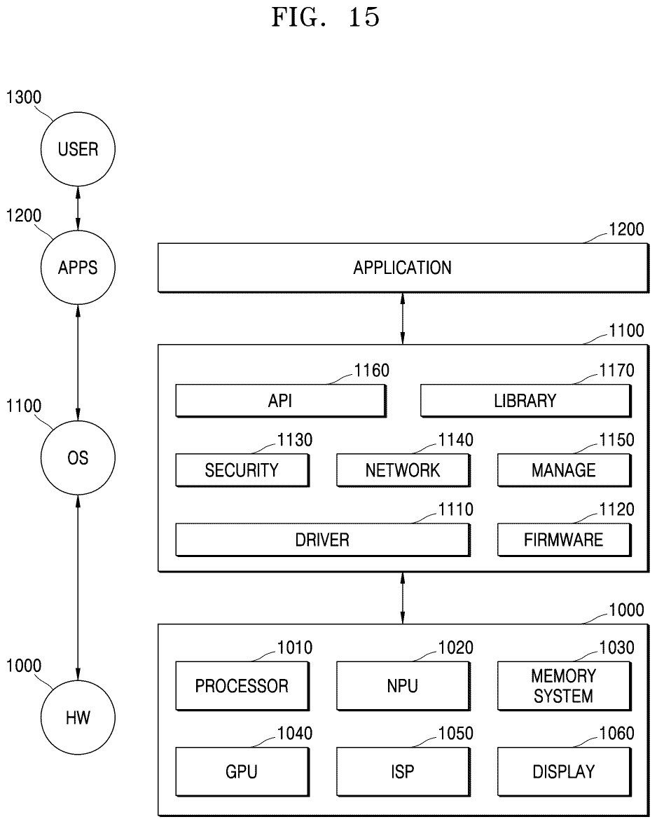

FIG. 15 illustrates a software layer of a system-on-chip, according to an embodiment. For convenience of description, pieces of hardware connected to the system-on-chip are illustrated together.

Referring to FIG. 15, an application 1200 and an operating system (OS) 1100 may be performed by a processor (e.g., the CPU 130a of FIG. 2). The application 1200 may denote a service and software for implementing a certain function. A user 1300 may denote an object using the application 1200. The user 1300 may communicate with the application 1200 through a user interface (UI). The application 1200 may be manufactured based on the purpose of each service and may communicate with the user 1300 through a UI suitable for the purpose of each service. The application 1200 may perform an operation requested by the user 1300, and depending on the case, the application 1200 may fetch content of each of an application protocol interface (API) 1160 and a library 1170.

The API 1160 and/or the library 1170 may perform a macro operation corresponding to a certain function, or when communication with a lower layer is needed, the API 1160 and/or the library 1170 may provide an interface. When the application 1200 requests an operation from the lower layer through the API 1160 and/or the library 1170, the API 1160 and/or the library 1170 may classify the request into a security 1130 field, a network 1140 field, and a manage 1150 field. The API 1160 and/or the library 1170 may operate a desired layer based on a requested field. For example, when the API 1160 requests a network 1140-related function, the API 1160 may transfer a desired parameter to a network 1140 layer and may fetch a relevant function. Then, the network 1140 may communicate with the lower layer in order to perform a requested task. For example, when there is no corresponding lower layer, the API 1160 and/or the library 1170 may directly perform a corresponding task.

A driver 1110 may perform a function which manages hardware 1000 and checks a state thereof, and then, receives a classified request from each of upper layers to transfer the received request to a hardware 1000 layer. When the driver 1110 requests a task from the hardware 1000 layer, firmware 1120 may convert a corresponding request to enable the hardware 1000 layer to accept the request. The firmware 1120 which converts the request to transfer to the hardware 1000 may be implemented to be included in the driver 1110 or the hardware 1000.

The API 1160, the driver 1110, and the firmware 1120 and the OS 1100 managing all of the elements may be embedded in the system-on-chip (e.g., at least one of the system-on-chip 10a of FIG. 4, the system-on-chip 10b of FIG. 10, and the system-on-chip 10c of FIG. 11). The OS 1100 may be stored in the form of control instruction codes and data in the memory system 1030. The hardware 1000 may include a processor 1010, an NPU 1020, a memory system 1030, a GPU 1040, an ISP 1050, and a display 1060. The hardware 1000 may perform requests (or commands) transferred by the driver 1110 and the firmware 1120 in order or in a changed order (out-of-order) and may store a performance result in a register of the hardware 1000 or the memory system 1030. The stored performance result may return to the driver 1110 and the firmware 1120.

In an embodiment, when a request to an AI operation is input to the user 1300 or the application 1200, the library 1170 of the OS 1100 may operate a desired layer, based on a corresponding request. The firmware 1120 may convert the corresponding request to transfer to the hardware 1000. The processor 1010 may transfer a command to the accelerator (for example, the NPU 1020 or the GPU 1040), based on the request received from the firmware 1120. The NPU 1020 or the GPU 1040 may perform a neural network operation in response to the command received from the processor 1010. Accordingly, the NPU 1020 or the GPU 1040 may perform a data prefetch operation, based on a memory access pattern predicted according to the neural network operation (e.g., a memory access pattern predicted to correspond to the neural network operation, or to be used by the neural network operation), and thus, the operation speed of the NPU 1020 or the GPU 1040 may be more enhanced.

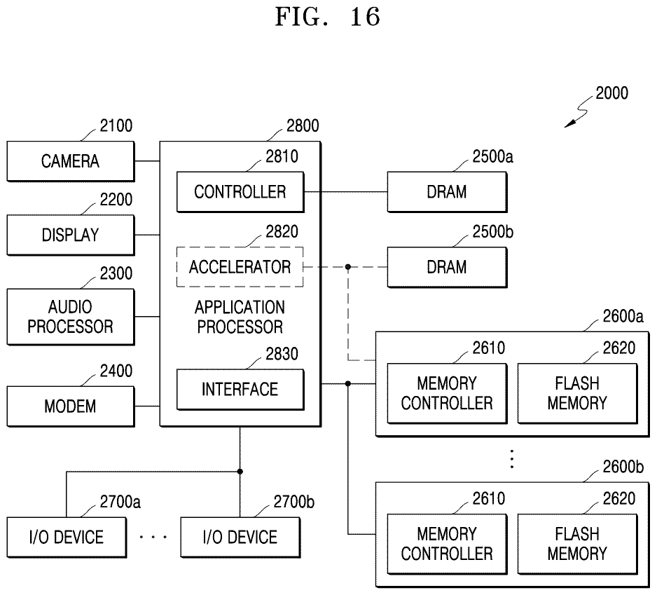

FIG. 16 is a block diagram illustrating an electronic system 2000 according to an embodiment.

Referring to FIG. 16, the electronic system 2000 may include a camera 2100, a display 2200, an audio processor 2300, a modem 2400, DRAMs 2500a and 2500b, flash memories 2600a and 2600b, input/output (I/O) devices 2700a and 2700b, and an application processor (AP) 2800. The electronic system 2000 may be implemented with a laptop computer, a mobile phone, a smartphone, a tablet personal computer (PC), a wearable device, a healthcare device, or an Internet of things (IoT) device. Also, the electronic system 2000 may be implemented with a server or a PC.

Based on control by a user, the camera 2100 may capture a static image or a moving image and may store the captured image/image data or may transmit the captured image/image data to the display 2200. The audio processor 2300 may process audio data included in content of the flash memories 2600a and 2600b or a network. The modem 2400 may modulate and transfer a signal in order to transmit or receive wired/wireless data, and a receiving side may demodulate a modulated signal in order to recover to an original signal. The I/O devices 2700a and 2700b may include devices, providing a digital input and/or output function, such as universal serial bus (USB) or a storage, a digital camera, a secure digital (SD) card, a digital versatile disc (DVD), a network adapter, and a touch screen.

The AP 2800 may control an overall operation of the electronic system 2000. The AP 2800 may include a controller 2810, an accelerator block or an accelerator chip 2820, and an interface block 2830. The AP 2800 may control the display 2200 so that a portion of content stored in the flash memories 2600a and 2600b is displayed on the display 2200. When a user input is received through the I/O devices 2700a and 2700b, the AP 2800 may perform a control operation corresponding to the user input. The AP 2800 may include an accelerator block which is a dedicated circuit for an AI operation, or may include an accelerator chip 2820 independently of the AP 2800. The DRAM 2500B may be additionally equipped in the accelerator block or the accelerator chip 2820. The accelerator may be a function block which dedicatedly performs a certain function of the AP 2800 and may include a GPU which is a function block for dedicatedly performing graphics data processing, an NPU which is a block for dedicatedly performing an AI operation and inference, and a data processing unit (DPU) which is a block for dedicatedly transmitting data.

The electronic system 2000 may include the DRAMs 2500a and 2500b. The AP 2800 may control the DRAMs 2500a and 2500b through a mode register (MRS) setting and a command according to joint electron device engineering council (JEDEC) standard, or may set DRAM interface protocol to perform communication in order to use a cyclic redundancy check (CRC)/error correction code (ECC) function and a company unique function such as low voltage/high speed/reliability. For example, the AP 2800 may communicate with the DRAM 2500a through an interface according to JEDEC standard such as low power double data rate 4 (LPDDR4) or LPDDR5, and the accelerator block or the accelerator chip 2820 may set new DRAM interface protocol to perform communication in order to control the DRAM 2500b, having a bandwidth which is higher than that of the DRAM 2500a, for accelerator.

In the example shown in FIG. 16, only the DRAMs 2500a and 2500b are illustrated, but embodiments are not limited thereto, and when bandwidth, response time, and voltage conditions of the AP 2800 or the accelerator chip 2820 are satisfied, any memory such as PRAM, SRAM, magnetoresistive random access memory (MRAM), RRAM, ferroelectric random access memory (FRAM), or hybrid RAM may be used. The DRAMs 2500a and 2500b may have a latency and a bandwidth which are relatively less than those of the I/O devices 2700a and 2700b or the flash memories 2600a and 2600b. The DRAMs 2500a and 2500b may be initialized at a power-on time of the electronic system 2000, and an OS and application data may be loaded therein, and thus, each of the DRAMs 2500a and 2500b may be used as a temporary storage for the OS and the application data, or may be used as an execution space for various software codes.

The four fundamental arithmetic operations such as addition/subtraction/multiplication/division, a vector operation, an address operation, or a fast Fourier transform (FFT) operation may be performed in or using the DRAMs 2500a and 2500b. Also, a function used for inference may be performed in the DRAMs 2500a and 2500b. Here, inference may be performed in a deep learning algorithm using a neural network. The deep learning algorithm may include a training operation of training a model through various data and an inference operation of recognizing data with a trained model. In an embodiment, an image captured by the camera 2100 of a user may be signal-processed and stored in the DRAM 2500b, and the accelerator block or the accelerator chip 2820 may perform an AI data operation of recognizing data by using a function used for inference and data stored in the DRAM 2500b.

The electronic system 2000 may include a plurality of storages or the flash memories 2600a and 2600b each having a capacity which is greater than that of the DRAMs 2500a and 2500b. The accelerator block or the accelerator chip 2820 may perform the training operation and the AI data operation by using the flash memories 2600a and 2600b. In an embodiment, the flash memories 2600a and 2600b may include a memory controller 2610 and flash memory 2620, and thus, the training operation and the AI data operation each performed by the AP 2800 and/or the accelerator chip 2820 may be more efficiently performed by using an operational device included in the memory controller 2610. The flash memories 2600a and 2600b may store an image captured by the camera 2100, and may store data transmitted through a data network. For example, the flash memories 2600a and 2600b may store at least one of augmented reality (AR), virtual reality (VR), high definition (HD), and ultra high definition (UHD) content.

In an embodiment, the accelerator block or the accelerator chip 2820 may be implemented as an accelerator which supports a data prefetch operation according to the embodiments described above. Therefore, the descriptions given above with reference to FIGS. 1 to 15 may be applied to the example shown in FIG. 16. For example, a prefetch operation may be performed based on a memory access pattern predicted according to a neural network operation performed by the accelerator chip 2820, and the AP 2800 or the accelerator chip 2820 may previously fetch data stored in the DRAM 2500b through the prefetch operation. Accordingly, the operation speed of the accelerator chip 2820 may be enhanced, and thus, the performance of the electronic system 2000 may be enhanced.

Hereinabove, exemplary embodiments are described with reference to the drawings. The particular terms used above to describe example embodiments merely used for convenience of description, and are not to limit a meaning or scope of the disclosure defined in the following claims. Therefore, it may be understood by those of ordinary skill in the art that various modifications and other equivalent embodiments may be implemented without departing from the scope of the disclosure. Accordingly, the spirit and scope of the disclosure may be defined based on the spirit and scope of the following claims.

While some examples are particularly shown and described above with reference to embodiments, it will be understood that various changes in form and details may be made therein without departing from the spirit and scope of the following claims.

What is claimed is:

1. A system-on-chip comprising:
an accelerator configured to generate a demand request for demand data corresponding to a neural network operation, based on an instruction received from a host processor, and to generate a prefetch request for prefetch data based on a memory access pattern predicted according to the neural network operation;
a memory controller configured to read the demand data from a memory based on the demand request, and to read the prefetch data from the memory based on the prefetch request; and
a system cache configured to store, as read data, at least one of the prefetch data and the demand data read from the memory,
wherein the accelerator is configured to perform the neural network operation on the read data received from the system cache.

2. The system-on-chip of claim 1, wherein the accelerator comprises:
a direct memory access (DMA) engine configured to generate the demand request based on the instruction;
a buffer configured to receive the read data from the system cache and buffer the received read data; and
a compute unit configured to perform the neural network operation on the read data buffered by the buffer.

3. The system-on-chip of claim 2, wherein the accelerator further comprises a prefetch module configured to receive the memory access pattern from the DMA engine and generate the prefetch request based on the received memory access pattern.

4. The system-on-chip of claim 3, wherein the memory access pattern is previously determined based on the neural network operation, and
wherein the memory access pattern comprises a memory read pattern corresponding to the demand request and a memory write pattern corresponding to the demand request.

5. The system-on-chip of claim 3, wherein the prefetch module comprises:
an access sequence queue configured to store the memory access pattern; and
a controller configured to generate the prefetch request.

6. The system-on-chip of claim 3, wherein, based on the memory being idle, the prefetch module is configured to issue the prefetch request, and the prefetch data is transferred to the system cache, and
based on the memory being busy, the prefetch request is deleted.

7. The system-on-chip of claim 3, wherein the DMA engine is configured to generate a demand count corresponding to a number of times that the demand request is issued, and
wherein the prefetch module is configured to generate a prefetch count corresponding to a number of times that the prefetch request is issued.

8. The system-on-chip of claim 7, wherein the accelerator is further configured to compare the demand count to the prefetch count, and control a prefetch operation based on a comparison result.

9. The system-on-chip of claim 8, wherein the prefetch module is further configured to:
determine whether a difference value obtained by subtracting the demand count from the prefetch count is less than a first distance,
based on the difference value being less than the first distance, determine whether the difference value is less than a second distance, wherein the second distance is less than the first distance, and
based on the difference value being greater than or equal to the second distance, and the memory being idle, issue the prefetch request and increment the prefetch count.

10. The system-on-chip of claim 9, wherein the prefetch module is further configured to:
based on the difference value being greater than or equal to the first distance, to stop the generating of the prefetch request until the demand count increments, and
based on the difference value is less than the second distance, delete the prefetch request and increment the prefetch count.

11. The system-on-chip of claim 9, wherein the first distance and the second distance are determined based on an available size of the system cache.

12. The system-on-chip of claim 7, wherein the prefetch module is further configured to store a plurality of prefetch entries corresponding to the memory access pattern,
wherein each of the plurality of prefetch entries comprises a first marker designating a process for updating the prefetch count, and
wherein the DMA engine comprises a second marker designating a process for updating the demand count.

13. The system-on-chip of claim 1, wherein the accelerator comprises at least one of a graphics processing unit (GPU) and a neural processing unit (NPU) configured to perform the neural network operation, and
wherein the neural network operation comprises at least one of a matrix operation and a convolution operation.

14. An operating method of a system-on-chip, the operating method comprising:
generating a demand request for demand data corresponding to a neural network operation, based on an instruction received from a host processor;
generating a prefetch request for prefetch data based on a memory access pattern predicted according to the neural network operation;
reading data from a memory based on at least one of the demand request and the prefetch request;
storing the read data in a system cache; and
performing the neural network operation on the read data received from the system cache,
wherein a priority of the demand request is higher than a priority of the prefetch request.

15. The operating method of claim 14, further comprising:
based on the memory being idle, issuing the prefetch request and transferring the prefetch data to the system cache; and
based on the memory being busy, deleting the prefetch request.

16. The operating method of claim 14, further comprising:
generating a demand count corresponding to a number of times that the demand request is issued;
generating a prefetch count corresponding to a number of times that the prefetch request is issued; and
comparing the demand count to the prefetch count, and performing a prefetch operation based on a comparison result.

17. The operating method of claim 16, wherein the performing of the prefetch operation comprises:
determining whether a difference value obtained by subtracting the demand count from the prefetch count is less than a first distance;
based on the difference value being less than the first distance, determining whether the difference value is less than a second distance, wherein the second distance is less than the first distance; and
based on the difference value being greater than or equal to the second distance, and the memory being idle, issuing the prefetch request and incrementing the prefetch count.

18. The operating method of claim 17, wherein the performing of the prefetch operation comprises:
based on the difference value is not less than the first distance, stopping the generating of the prefetch request until the demand count increments; and
when the difference value is less than the second distance, deleting the prefetch request and incrementing the prefetch count.

19. The operating method of claim 17, wherein the first distance and the second distance are determined based on an available size of the system cache.

20. An accelerator for performing a task corresponding to an instruction received from a host processor, the accelerator comprising:
an execution sequence generator configured to dispatch a plurality of operations associated with the task;
a fetch module configured to generate a demand request for demand data corresponding to the plurality of operations;
a prefetch module configured to generate a prefetch request for prefetch data based on a memory access pattern corresponding to the plurality of operations;
a buffer memory configured to store at least one of the demand data and the prefetch data;
a cache memory configured to receive data comprising at least one of the demand data and the prefetch data from the buffer memory, and store the received data; and
a compute unit configured to perform the plurality of operations on the received data stored in the cache memory,
wherein a priority of the demand request is higher than a priority of the prefetch request.
